(19) United States
(12) Patent Application Publication
(10) Pub. No.: US 2013/0099671 A1
(43) Pub. Date: Apr. 25, 2013

(54) POWER SUPPLY DEVICE AND DRIVING DEVICE

(71) Applicant: SAMSUNG ELECTRONICS CO., LTD., Suwon-si (KR)

(72) Inventors: Mamoru HORINO, Suwon (KR); Yoshio FUJIMURA, Suwon (KR); Masami NEI, Suwon (KR)

(73) Assignee: SAMSUNG ELECTRONICS CO., LTD., Suwon-si (KR)

(21) Appl. No.: 13/654,081

(22) Filed: Oct. 17, 2012

(30) Foreign Application Priority Data
Oct. 18, 2011 (KR) 10-2011-0106480
Mar. 8, 2012 (KR) 10-2012-0023819
Mar. 30, 2012 (KR) 10-2012-0033493

(51) Int. Cl. H05B 37/02

(52) U.S. Cl. CPC H05B 37/02
USPC 315/122

(57) ABSTRACT

A power supply device includes a driving device. The power supply device supplies DC power to a light source unit having multiple light sources. The driving device determines whether a current flowing in the light source unit is outside a pre-set current range. When the current flowing in the light source unit is outside the pre-set current range, the driving device changes the number of light sources driven in the light source unit.

### CROSS-REFERENCE TO RELATED APPLICATIONS

This application claims benefit of priority to Korean Patent Applications No. 10-2011-0106480 filed on Oct. 18, 2011, No. 10-2012-0023819 filed on Mar. 8, 2012, and No. 10-2012-0033493 filed on Mar. 30, 2012, in the Korean Intellectual Property Office, the entire contents of which are hereby incorporated by reference.

### BACKGROUND

1. Technical Field

The present disclosure relates to a power supply device and a driving device.

2. Description of the Related Art

A light emitting device (e.g., a light emitting diode (LED)) refers to a semiconductor device capable of implementing various colors of light by configuring a light emitting source with various compound semiconductor materials such as GaAs, AlGaAs, GaN, InGaAlP, and the like. An LED, advantageously having an excellent monochromic peak wavelength and excellent optical efficiency, being compact and environmentally friendly, and consuming low levels of power, and the like, is widely used for various applications such as in TVs, computers, illumination devices, automobile lighting devices, and the like.

In such a light emitting device (or an LED), a current tends to increase exponentially with respect to a voltage applied to both ends thereof. Thus, in case of applying an illumination device using a light emitting device as a light source to commercial AC power used in homes, offices, outdoor areas, and the like, a constant current circuit generating a constant current is generally used. That is, in an light emitting device (or an LED), a current is very susceptible to changing with respect to an applied voltage. A need exists for an apparatus or a method for stably controlling a current flowing in an LED in order to use AC power having a wide variation in voltages as input power.

### SUMMARY

An aspect of the present disclosure relates to a power supply device having a high level of efficiency and incurring low costs and an LED driving device using the same.

An aspect of the present disclosure encompasses a power supply device that supplies DC power to a light source unit, including a driving device. The driving device may determine whether a current flowing in the light source unit is outside a pre-set current range, and change the number of light sources driven in the light source unit when the current flowing in the light source unit is outside the pre-set current range.

The driving device of the power supply device may detect a current flowing in the light source unit at an output terminal of the light source unit to generate an input signal and compare the input signal with a reference signal to determine whether or not the input signal is outside the pre-set current range.

The driving device of the power supply device may include a comparator, a switch controller and a switch. The comparator may compare the input signal generated upon detecting the current flowing in the light source unit with the reference signal, and output a control signal when the input signal is outside the pre-set current range. The switch controller may receive the control signal outputted from the comparator, and output a signal for changing the number of light sources driven in the light source unit when the control signal is inputted to the switch controller. The switch is connected to the light source unit and is turned on or off according to a signal outputted from the switch controller.

When a current detected from the output terminal of the light source unit is outside the pre-set current range, the comparator may output one of an upper limit control signal and a lower limit control signal.

When the upper limit control signal is inputted, the switch controller may output a first control signal to increase the number of driven light sources. When the lower limit control signal is inputted, the switch controller may output a second control signal to decrease the number of driven light sources.

The driving device of the power supply device may further include a condenser connected in parallel with at least a portion of the light sources driven in the light source unit.

The light source unit may include first to nth LED groups sequentially connected in series. The condenser may be connected to two ends of the first LED group.

The driving device of the power supply device may include a comparator, a switch controller, a switch and a flicker preventing circuit. The comparator may detect a current flowing in the light source unit at an output terminal of the light source unit to generate an input signal, compare the input signal with a reference signal, and output one of an upper limit control signal and a lower limit control signal when the input signal is outside the pre-set current range. The switch controller may receive the one of the upper limit control signal and the lower limit control signal outputted from the comparator, and output a signal for changing the number of light sources driven in the light source unit when the one of the upper limit control signal and the lower limit control signal is inputted to the switch controller. The switch may be connected to the light source unit and be turned on or off according to a signal outputted from the switch controller. The flicker preventing circuit may forcibly turn the switch off, when the upper limit control signal is not outputted during a certain period within an interval from a point time when the upper limit control signal is first outputted to a point time when the lower limit control signal is first output, in one cycle of driving of the DC power.

The driving device of the power supply device may include a comparator, a switch controller and a switch. The comparator may detect a current flowing in the light source unit at a output terminal of the light source unit to generate an input signal, compare the input signal with a reference signal, and output a control signal when the input signal is outside the pre-set current range. The switch controller may receive the control signal outputted from the comparator, and output a signal for changing the number of light sources driven in the light source unit when the control signal is inputted to the switch controller. The switch may be connected to the light source unit and be turned on or off according to a signal outputted from the switch controller. The comparator may include a first comparator and a second comparator. The first comparator may compare the input signal with a first reference signal, and output an upper limit control signal when the input signal is greater than the first reference signal. The second comparator may compare the input signal with a second reference signal, and output a lower limit control signal when the input signal is smaller than the second reference signal.

The first and second comparators may be operational amplifiers. The first reference signal may be inputted to an inverting input terminal of the first comparator. The input signal may be inputted to a non-inverting input terminal of the first comparator. The input signal may be inputted to an inverting input terminal of the second comparator. The second reference signal may be inputted to a non-inverting input terminal of the second comparator.

The driving device of the power supply device may further include a voltage regulator outputting a certain voltage upon receiving a portion of the DC power and multiple resistors connected in series between an output terminal of the voltage regulator and a ground. Each of the first reference signal and the second reference signal is set to have a voltage distributed by the multiple resistors.

The comparator may further include a current detection resistor connected between the output terminal of the light source unit and a ground. The input signal may be generated in the form of a voltage over the current detection resistor.

The light source unit may include first to nth LED groups sequentially connected in series. The switch may include first to (n−1)th switches connected between output terminals of the first to (n−1)th LED groups and the current detection resistor, respectively.

The switch controller may control an ON/OFF operation of the switch.

The power supply device may further include a rectifying unit converting AC power inputted from the outside into the DC power.

The rectifying unit may include a bridge diode.

Another aspect of the present disclosure relates to a driving device including a comparator, a switch controller and a switch. The comparator may compare an input signal with a reference signal, and output a control signal when the input signal is outside a current range previously set based on the reference signal. The switch controller may receive the control signal outputted from the comparator, and output a signal for changing the number of light sources driven in a light source unit when the control signal is inputted to the switch controller.

When the input signal is outside the current range previously set based on the reference signal, the comparator may output one of an upper limit control signal and a lower limit control signal.

When the upper limit control signal is inputted, the switch controller may output a first control signal to increase the number of driven light sources. When the lower limit control signal is inputted, the switch controller may output a second control signal to decrease the number of driven light sources.

The driving device may further include a condenser connected in parallel with at least a portion of light sources driven in the light source unit.

The light source unit may include first to nth LED groups. The condenser may be connected to two ends of the first LED group.

The comparator may output one of an upper limit control signal and a lower limit control signal when the input signal is outside the current range previously set based on the reference signal. The driving device further includes a flicker preventing circuit forcibly turning the switch off controlled by the switch controller, when the upper limit control signal is not outputted during a certain period within an interval from a point time when the upper limit control signal is first outputted to a point time when the lower limit control signal is first output, in one cycle of driving of the DC power.

The comparator may include a first comparator and a second comparator. The first comparator may compare the input signal with a first reference signal, and output an upper limit control signal when the input signal is greater than the first reference signal. The second comparator may compare the input signal with a second reference signal, and output a lower limit control signal when the input signal is smaller than a second reference signal.

The first and second comparators may be operational amplifiers. The first reference signal may be inputted to an inverting input terminal of the first comparator. The input signal may be inputted to a non-inverting input terminal of the first comparator. The input signal may be inputted to an inverting input terminal of the second comparator. The second reference signal may be inputted to a non-inverting input terminal of the second comparator.

The driving device may further include a voltage regulator receiving a portion of the DC power and outputting a certain voltage and multiple resistors connected in series to an output terminal of the voltage regulator. Each of the first reference signal and the second reference signal is set to have a voltage distributed by the plurality of resistors.

### BRIEF DESCRIPTION OF THE DRAWINGS

The foregoing and other features of the present disclosure will be apparent from more particular description of embodiments of the present disclosure, as illustrated in the accompanying drawings in which like reference characters may refer to the same or similar parts throughout the different views. The drawings are not necessarily to scale, emphasis instead being placed upon illustrating the principles of the embodiments of the present disclosure. In the drawings, the thickness of layers and regions may be exaggerated for clarity.

FIG. 1 is a view schematically illustrating an exemplary light emitting device including a power supply device and a driving device according to an embodiment of the present disclosure;

FIG. 2 is a view illustrating an example of the light emitting device including a power supply device and a driving device according to the embodiment of the present disclosure illustrated in FIG. 1;

FIG. 3A, FIG. 3B and FIG. 3C are a view schematically illustrating waveforms of voltages and currents applicable to a power supply device and a driving device according to an embodiment of the present disclosure;

FIG. 4 is a view schematically illustrating an exemplary light emitting device including a power supply device and a driving device according to another embodiment of the present disclosure;

FIG. 5A, FIG. 5B and FIG. 5C are a view illustrating waveforms of voltages and currents that may be driven by the power supply device and driving device illustrated in FIG. 4;

FIG. 6A and FIG. 6B are a view illustrating operations of the power supply device and driving device illustrated in FIGS. 4 and 5A to 5C;

FIG. 7 is a view illustrating an exemplary light emitting device including a power supply device and a driving device according to another embodiment of the present disclosure; and

FIG. 8 is a view schematically illustrating waveforms of voltages and currents applicable to a power supply device and a driving device according to another embodiment of the present disclosure.

### DETAILED DESCRIPTION OF THE PREFERRED EMBODIMENT

Embodiments of the present disclosure will now be described in detail with reference to the accompanying drawings.

The foregoing and other features of the present disclosure will be apparent from more particular description of embodiments of the present disclosure, as illustrated in the accompanying drawings in which like reference characters may refer to the same or similar parts throughout the different views. The drawings are not necessarily to scale, emphasis instead being placed upon illustrating the principles of the embodiments of the present disclosure. In the drawings, the thickness of layers and regions may be exaggerated for clarity.

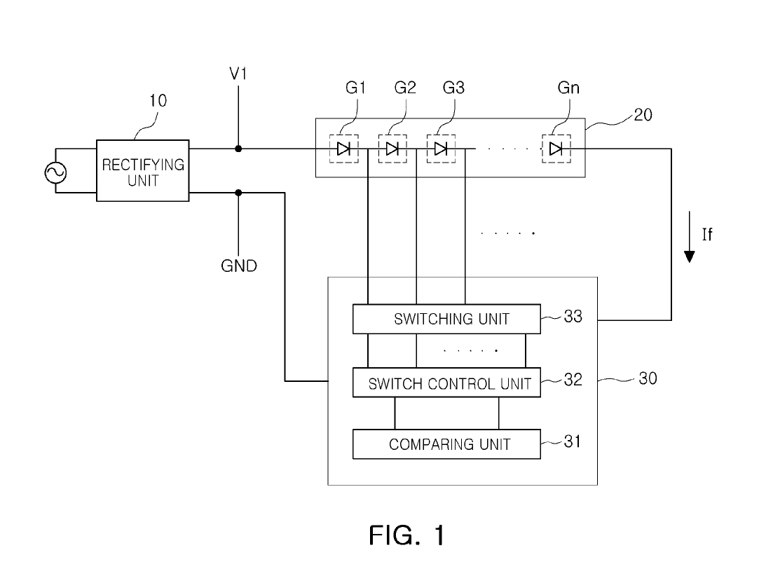

FIG. 1 is a view schematically illustrating an exemplary light emitting device including a power supply device and a driving device according to an embodiment of the present disclosure.

Referring to FIG. 1, a power supply device 30 according to the embodiment of the present disclosure supplies DC power to a light source unit 20, and detects a current flowing in the light source unit 20. When the detected current is outside a pre-set current range, the power supply device 30 may control to change the number of light sources driven in the light source unit 20.

The light source unit 20 applicable to the power supply device 30 according to the embodiment of the present disclosure may include first to nth LED groups G1, G2, . . . , Gn sequentially connected in series and driven by DC power. The power supply device 30 detects a current flowing in an output terminal of the light source unit 20, and when the detected current is outside the pre-set current range, the power supply device 30 may change the number of LED groups driven in the light source unit 20.

In the embodiment of the present disclosure, the power supply device 30 may further include a rectifying unit 10 converting AC power inputted from the outside into DC power. The DC power converted by the rectifying unit 10 may be inputted to the light source unit 20. A resistor R1 is connected between the rectifying unit 10 and the light source unit 20.

The rectifying unit 10 may rectify AC power (e.g., commercial AC power of 220 VAC or 100 VAC) applied from the outside. Of the output voltage rectified by the rectifying unit 10, a side connected to the light source unit 20 refers to a high potential side, and a side connected to the power supply unit 30 refers to a lower potential side. In the embodiment of the present disclosure, the lower potential side may be understood as a reference potential, i.e., a ground (GND). Thus, a current may flow from the rectifying unit through the light source unit 20 to the ground GND. In the embodiment of the present disclosure, external AC power may be full-wave rectified by the rectifying unit 10.

Meanwhile, DC power described in the embodiment of the present disclosure refers to DC power having a broad meaning covering power which changes over time but has a uniform polarity, as well as power having uniform voltage magnitude over time. Also, a fundamental frequency in a voltage change is assumed to be 100 Hz or higher so that a flicker cannot be recognized by human being's eyes.

The light source unit 20 may include first to nth LED groups G1, G2, . . . , Gn, and the first to nth LED groups G1, G2, . . . , Gn may be connected to the power supply device 30, respectively. The first to nth LED groups G1, G2, . . . , Gn are devices using at least one LED as a light source. In case of a plurality of LEDs, the plurality of LEDs may be configured to have various electrical connection relationships including series connections, parallel connections, or series parallel connections and driven as a single unit. In FIG. 1, respective LED groups G1, G2, . . . , Gn constituting the light source unit 20 are illustrated as including a single LED for the purposes of description, but the present disclosure is not limited thereto and a plurality of LEDs may be configured to have various electrical connection relationships.

In the embodiment of the present disclosure, the power supply device 30 may control such that at least a portion of the first to nth LED groups G1, G2, . . . , Gn constituting the light source unit 20 is driven according to a magnitude of a voltage V1 outputted from the rectifying unit 10.

The power supply device 30 may increase the number of driven LED groups during an interval (or a section) in which the magnitude of the rectified DC power voltage V1 is increased, and decrease the number of LED groups driven during an interval in which the magnitude of the rectified DC power voltage is decreased, thereby driving a maximum number of LED groups that can be driven according to the magnitude of the periodically changed input voltage V1. Here, the operation of decreasing and increasing the number of driven LED groups may be controlled by detecting a current flowing in the light source unit 20, comparing the detected current with a reference signal, and maintaining the detected current within a certain range.

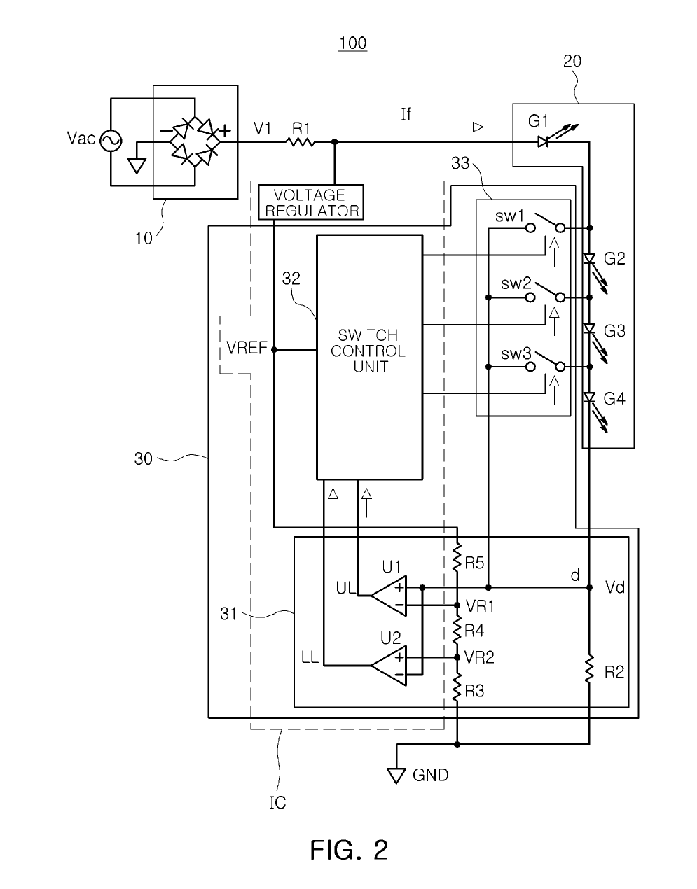

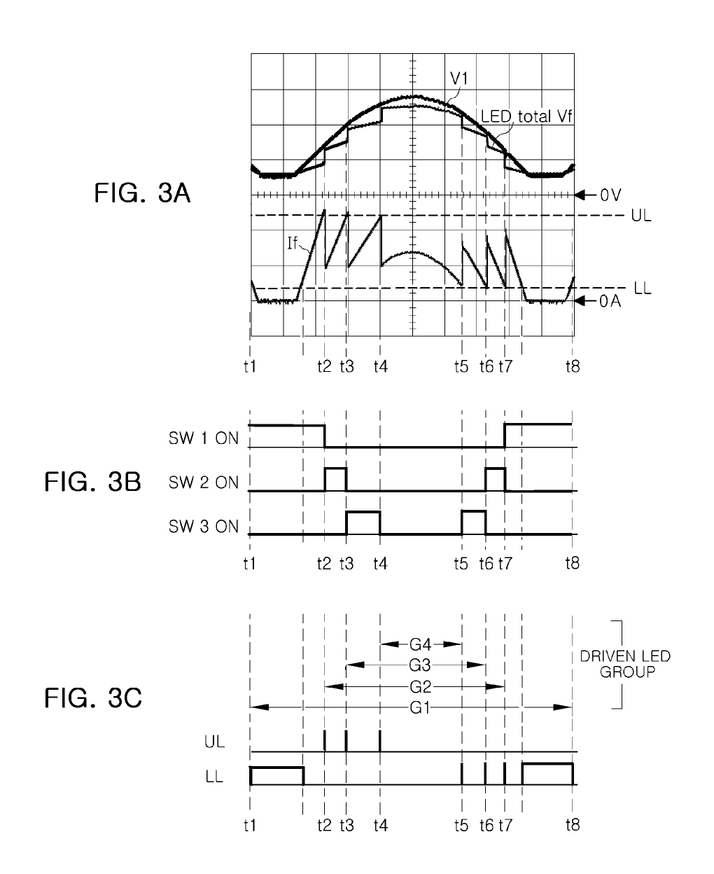

Hereinafter, an operation of the power supply device 30 will be described in detail with reference to FIGS. 2 and 3.

FIG. 2 is a view illustrating an exemplary light emitting device 100 including a power supply device and a driving device according to the embodiment of the present disclosure illustrated in FIG. 1. FIG. 3 is a view schematically illustrating waveforms of voltages and currents applicable to a power supply device and a driving device according to an embodiment of the present disclosure.

First, referring to FIG. 2, the power supply device 30 according to the embodiment of the present disclosure supplies DC power to the light source unit 20. The power supply device 30 detects a current flowing in the light source unit 20, and when the detected current is outside the pre-set current range, the power supply device 30 may control to change the number of light sources driven in the light source unit 30.

The power supply unit 30 may further include the rectifying unit 10 for converting AC power inputted from the outside into DC power. The power supply unit 30 may supply driving power to the light source unit 20 including the first to nth LED groups sequentially connected in series and driven by the DC power converted by the rectifying unit 10. The power supply device 30 detects a current flowing in the output terminal of the light source unit 20, and when the detected current is outside the pre-set current range, the power supply device 30 may change the number of LED groups driven in the light source unit 20.

In the embodiment of the present disclosure, in order to convert an AC power Vac inputted from the outside into DC power, a bridge diode may be applied. The DC power voltage V1 rectified in the rectifying unit 10 has a form of a sinusoidal wave, and a driving current If flows from an output terminal of the rectifying unit 10 to the ground GND through the light source unit 20.

The light source unit 20 includes, for example, first to fourth LED groups G1, G2, G3, and G4 sequentially connected in series to an output terminal of the rectifying unit 10. The first to fourth LED groups G1, G2, G3, and G4 include a single LED, but the present disclosure is not limited thereto and each group may include a plurality of LEDs connected in series and parallel.

In the LED driving circuit using general AC commercial power as an input, in case that a plurality of LEDs are connected in series to the output terminal of the rectifying unit 10 configured as a bridge diode, excluding a boost circuit of an switched-mode power supply (SMPS), a current does not flow during an interval in which the output voltage V1 of the rectifying unit 10 is lower than the overall driving voltage of the plurality of LEDs. That is, all the LEDs can be driven only during an interval in which the output voltage V1 of the rectifying unit 10 is higher than a driving voltage Vf in a full-wave rectified sinusoidal wave. All the LEDs cannot be driven during an interval in which the output voltage V1 is lower than the driving voltage Vf.

However, in the power supply device 30 according to an embodiment of the present disclosure, since at least a portion of the first to nth LED groups G1, G2, . . . , Gn are sequentially turned on according to the magnitude of the rectified power source voltage V1 by a switch 31, the interval in which all the LEDs are not turned on is minimized to enhance driving efficiency.

Also, a small capacitor may be disposed in the output terminal of the rectifying unit 10 to remove an interval in which the driving current If is 0, while satisfying power current harmonics regulation.

To this end, the power supply device 30 may include a comparator 31 connected to the output terminal of the light source unit 20, a switch controller 32, and a switch 33. The comparator 31 compares an input signal generated by detecting a current flowing in the light source unit 20 with the reference signal, and outputs a control signal when the input signal is outside the pre-set current range. The switch controller 32 outputs a control signal to increase or decrease the number of LED groups driven upon receiving the control signal outputted from the comparator 31. The switch 33 is connected to at least a portion of the first to nth LED groups G1, G2, . . . , Gn, and here, specifically, the first to fourth LED groups G1, G2, G3, and G4, and turned on or off according to a signal outputted from the switch controller 32.

Here, when a current detected from the output terminal of the light source unit 20 is outside the pre-set current range, the comparator 31 may output an upper limit control signal or a lower limit control signal, and control the switch controller 32 to increase the number of driven LED groups when the upper limit control signal is inputted, and decrease the number of driven LED groups when the lower limit control signal is inputted.

The comparator 31 may include at least two first and second comparators U1 and U2 detecting a current flowing in the light source unit 20 and comparing the detected current with a reference signal. For example, a comparator or an operational amplifier (OP amp) may be applied as the first and second comparators.

The first comparator U1 may compare the input signal with a first reference signal VR1, and when the input signal is greater than the first reference signal VR1, the first comparator U1 may output an upper limit control signal UL. The second comparator U2 may compare the input signal with a second reference signal VR2, and when the input signal is smaller than the second reference signal VR2, the second comparator U2 may output a lower limit control signal LL.

Here, the first reference signal VR1 may be inputted to an inverting input terminal (−) of the first comparator U1, and the second reference signal VR2 may be inputted to a non-inverting input terminal (+) of the second comparator U2. The first and second reference signals VR1 and VR2 are fixed values, and in the embodiment of the present disclosure, the first and second reference signals VR1 and VR2 may be set as a portion of a voltage VREF stabilized by a voltage regulator. Although not specifically shown, the switch controller may be driven by using a portion of a voltage outputted from the voltage regulator.

The voltage regulator is connected to an output terminal of the rectifying unit 10 to receive a portion of the DC power voltage V1 converted by the rectifying unit 10 and output a uniform voltage, and a plurality of resistors R3, R4, and R5 may be connected between the output terminal of the voltage regulator and the ground GND. Here, the first and second reference signals VR1 and VR2, inputted to the first and second comparators U1 and U2, may be set to have voltages distributed by the plurality of resistors R3, R4, and R5.

In detail, in the embodiment illustrated in FIG. 2, the first reference signal VR1 may be set to

$$\frac{R 3 + R 4}{R 3 + R 4 + R 5} VREF ,$$

and similarly, the second reference signal VR2 may be set to

$$\frac{R 3}{R 3 + R 4 + R 5} VREF .$$

Here, the first and second reference signals VR1 and VR2 may set an upper limit (If(UL)) and a lower limit (If(LL)) of the current flowing in the light source unit 20.

The upper limit (UL) and the lower limit (LL) of the driving current If detected from an output terminal d of the light source unit 20 may be set based on the sizes of the resistors R3, R4, and R5 connected between the first and second comparators U1 and U2 and the ground GND, and based on the size of a resistor R2 connected between an output terminal of the light source unit 20a and the ground GND, as follows. Here, the upper limit and the lower limit of the driving current may be set in consideration of the driving voltage of the LED groups constituting of the light source unit 20.

$$\begin{matrix}If ( UL ) = \frac{1}{R 2} \frac{R 3 + R 4}{R 3 + R 4 + R 5} VREF \\ If ( LL ) = \frac{1}{R 2} \frac{R 3}{R 3 + R 4 + R 5} VREF\end{matrix}$$

When the driving current If is smaller than the upper limit (If(UL)) (i.e., If>If(UL)) through the first comparator U1, the comparator 31 may output the upper limit control signal UL to the switch controller 32 to control the switch controller 32 to increase the number of driven LED groups according to the upper limit control signal UL.

Conversely, when the driving current If is higher than the lower limit (If(LL)) (i.e., If<If(LL)) through the second comparator U2, the comparator 31 may output the lower limit control signal LL to the switch controller to control the switch controller 32 to decrease the number of driven LED groups according to the lower limit control signal LL.

In detail, the first comparator U1 receives a voltage Vd detected from the current flowing in the light source unit 20 at a non-inverting input terminal (+) thereof and the first reference signal VR1 at a inverting input terminal (−) thereof, and compares the magnitudes of Vd and VR1. When the voltage Vd is greater than the first reference signal VR1, the first comparator U1 may generate the upper limit control signal UL to the switch controller 32.

Meanwhile, the second comparator U2 receives the voltage Vd detected from the current flowing in the light source unit 20 at an inverting input terminal (−) thereof and the second reference signal VR2 at a non-inverting input terminal (+) thereof, and compares the magnitudes of Vd and VR2. When the voltage Vd is smaller than the second reference signal VR2, the second comparator U2 may generate the lower limit control signal LL to the switch controller 32.

The switch controller 32 receives the upper limit control signal UL or the lower limit control signal LL outputted from the comparator 31. When the upper limit control signal UL is inputted from the first comparator U1, the switch controller 32 may be controlled to increase the number of driven LED groups, and conversely, when the lower limit control signal LL is inputted from the second comparator U2, the switch controller 32 may be controlled to decrease the number of driven LED groups. Here, a shift resistor (not separately shown), a counter (not separately shown), a decoder (not separately shown), or the like, may be applied to the switch controller 32, but the present disclosure is not limited thereto.

The switch 33 is connected to at least a portion of the output terminal of the first to nth LED groups G1, G2, . . . , Gn so as to be turned on or off to thus change a path of a current flowing in the light source unit 20.

As illustrated in FIG. 2, the switch 33 may include first to (n−1)th switches SW1, SW2, . . . , SWn−1 connected between output terminals of the first to (n−1)th groups G1, G2, . . . , Gn−1 among the first to nth LED groups G1, G2, . . . , Gn and the current detection resistor R2, respectively. Also, another active or passive element may be added between the output terminals of the LED groups and the ground GND.

For example, when the second switch SW2 is closed and the first to third switches SW1 and SW3 are open, the current If flows through the first and second LED groups G1 and G2, the second switch SW2, and the resistor R2 to the ground GND. Here, when the voltage Vd (Vd=If×R2) detected in the comparator 31 is between the first and second reference signals VR1 and VR2, the first to third switches SW1, SW2, and SW3 are maintained to be the same as before.

Meanwhile, when the voltage Vd detected in the comparator 31 is greater than the first reference signal VR1, the second switch SW2 is open and the third switch SW3 is closed, and thus, the driving current If flows from the first to third LED groups G1, G2, and G3, through the resistor R2, to the ground GND, and conversely, when the voltage Vd detected in the comparator 31 is smaller than the second reference signal VR2, the second switch SW2 is open and the first switch SW1 is closed, so the driving current If flows from the first LED group G1, through the resistor R2, to the ground GND.

FIGS. 3A-3C are views schematically illustrating waveforms of voltages and currents applicable to a power supply device and a driving device according to an embodiment of the present disclosure. In detail, FIGS. 3A-3C illustrate waveforms of voltages and currents, and operations of the LED groups and switches when the power supply device 30 illustrated in FIG. 2 is employed, during one period of a rectified DC power voltage V1.

Two waveforms shown in an upper portion of FIG. 3A are waveforms of the voltage V1 which is full-wave rectified by the rectifying unit 10 and the total LED driving voltage Vf of the first to fourth LED groups G1, G2, G3, and G4. A waveform shown in a lower portion of FIG. 3A denotes the driving current If flowing in the light source unit 20. FIG. 3B shows an ON/OFF operation of the first to third switches SW1, SW2, and SW3. FIG. 3C illustrates signals detected from the first and second comparators U1 and U2 of the comparator 31 and LED groups driven according to the signals.

Hereinafter, an operation and a driving method in one period of the full-wave rectified DC power voltage V1 will be described in detail. Here, the rectified DC power voltage V1 is only used to drive the light source unit 20 for the purposes of description and helping those skilled in the art to easily understand the present disclosure, and power consumed to drive the remaining circuits is so small as not to be considered.

However, referring to FIG. 2 and FIG. 3, the light emitting device according to the embodiment of the present disclosure is not limited to the embodiment in which the rectified DC power voltage V1 is only applied to drive the light source unit 20. It would be appreciated by a person skilled in the art that a portion of the rectified DC power voltage V1 is used as power for driving a different driving circuit.

A method for driving an LED according to an embodiment of the present disclosure may include detecting a current flowing in the first to nth LED groups G1, G2, . . . , Gn sequentially connected in series to rectified DC power, setting a driving current range for controlling a current flowing in the first to nth LED groups G1, G2, . . . , Gn, and providing control to change the number of driven LED groups at a timing when the current detected from the first to nth LED groups G1, G2, . . . , Gn moves out of the pre-set current range.

First, as for an operation during an interval t1˜t2, the driving current If does not flow (If=0) in an initial stage in which a voltage is low, and the voltage Vd detected by the driving current If at this time has a value smaller than the second reference signal VR2 of the second comparator U2 (Here, the reference signal of the second comparator U2 may be set to have an appropriate value by using a resistor as described above). Thus, the second comparator U2 outputs a lower limit control signal LL to control the switch controller 32 to turn on the first switch SW1. Once the first switch SW1 is turned on, even if the lower limit control signal LL is detected as (H) thereafter, the state of the first switch SW1 is not changed. As the DC power voltage V1 is gradually increased, the driving current If starts to flow and the voltage Vd detected by the driving current If has a value greater than the first reference signal VR1 and smaller than the second reference signal VR2 (i.e., VR1<Vd<VR2), and even in this case, the first switch SW1 is maintained in a closed state.

As the DC power voltage V1 is increased, the driving current If is also increased together therewith, and when the voltage Vd detected by the driving current If is greater than the first reference signal VR1 of the first comparator U1, i.e., when the timing t2 in FIG. 3 arrives, the first comparator U1 may output the upper limit control signal UL to the switch controller 3 to control the switch controller 32 to turn off the first switch SW1 and turn on the second switch SW2 according to the upper limit control signal inputted from the first comparator U1, thus increasing the number of driven LEDs.

Here, the driving current If, which has flowed from the first LED group G1 to the ground GND through the first switch SW1 and the R2, currently flows from the first and second LED groups G1 and G2 to the ground GND through the second switch SW2. Also, at the instant (t2) when the first switch SW1 is turned off and the second switch SW2 is turned on, the driving voltage Vf is increased by the second LED group G2, and thus, the driving current If is instantly reduced.

Hereinafter, it is assumed that the first to fourth LED groups G1, G2, G3, and G4 have the same driving voltage Vf0 for the purposes of description. The driving current If at the timing t2 is reduced by the additionally driven second LED group G2, and specifically, the driving current If is changed from

$$If = \frac{V 1 - Vf 0}{R 1 + R 2} to If = \frac{V 1 - 2 Vf 0}{R 1 + R 2} .$$

Next, as for an operation during an interval from the timing t2 to the timing t3 (t2˜t3), in a state in which the driving current If is reduced, as the rectified DC power voltage V1 is increased, the driving current If and the voltage Vd detected by the driving current If are also gradually increased.

When the voltage Vd detected by the driving current If is greater than the first reference signal VR1 (i.e., Vd>VR1), that is, when the timing t3 arrives, the first comparator U1 outputs the upper limit control signal UL to the switch controller 32 and outputs a signal H for controlling the switch controller 32 to turn off the second switch SW2 and turn on the third switch SW3 to thus drive a larger number of LEDs. Here, the driving current If, which has flowed from the first and second LED groups G1 and G2 to the ground GND through the resistor R2, currently flows from the first to third LED groups G1, G2, and G3 to the ground GND through the resistor R2. As the driving voltage Vf of the LED is increased at the timing t3, the driving current If is instantly reduced. That is, the driving current If at the timing t3 may be changed from

$$If = \frac{V 1 - 2 Vf 0}{R 1 + R 2} to If = \frac{V 1 - 3 Vf 0}{R 1 + R 2} .$$

Next, as for an operation of an interval from the timing t3 to an timing t4 (i.e., t3˜t4), when the voltage Vd detected by the reduced driving current If is between the first reference signal VR1 and the second reference signal VR2, i.e., in case of VR2<Vd<VR1, the driving current If flows through the first to third LED groups G1, G2, and G3, and thus, the first to third LED groups G1, G2, and G3 can operate.

Similar to the above case, when the driving current If is gradually increased and the voltage Vd detected by the driving current If is greater than the first reference voltage VR1 (at the timing t4), the switch controller 32 may be controlled to turn off the third switch SW3, thus turning off all the switches, to allow the driving current If to flow through the first to fourth LED groups G1, G2, G3, and G4. That is, the driving current If at the timing t4 may be changed from

$$If = \frac{V 1 - 3 Vf 0}{R 1 + R 2} to If = \frac{V 1 - 4 Vf 0}{R 1 + R 2} .$$

As for an operation during an interval from the timing t4 to the timing t5 (i.e., t4˜t5), when the third switch SW3 is turned off at the timing t4 and the voltage Vd detected by the driving current If is between the first reference voltage VR1 and the second reference voltage VR2, the third switch SW3 is maintained in the OFF state.

At this time, the driving current If flows from the first to fourth LED groups G1, G2, G3, and G4, through the resistor R2, to the ground GND. As the rectified DC power voltage V1 reaches a peak and is subsequently gradually reduced, the driving current If is also reduced together.

According to the reduction in the driving current If, when the voltage Vd detected by the driving current If is smaller than the second reference signal VR2 of the second comparator U2, i.e., when the timing t5 arrives, the second comparator U2 may output the lower limit control signal LL to the switch controller 32 to control the switch controller 32 to turn on the third switch SW3 to reduce the number of driven LEDs. In this case, the fourth LED group G4 is turned off and only the first to third LED groups G1, G2, and G3 are driven.

At this time, since the number of driven LEDs is instantly reduced, the LED driving voltage Vf is reduced and the driving current If is temporarily increased. Specifically, the driving current If at the timing t5 may be changed from

$$If = \frac{V 1 - 4 Vf 0}{R 1 + R 2} to If = \frac{V 1 - 3 Vf 0}{R 1 + R 2} .$$

As for an operation during an interval from the timing t5 to the timing t6 (i.e., t5˜t6), the increased driving current If is gradually decreased according to the reduction in the DC power voltage V1 from the peak. In this case, when the voltage Vd detected by the driving current If is between the first reference signal VR1 and the second reference signal VR2 (i.e., VR2<Vd<VR1), the state of the first to third switches SW1, SW2, and SW3 is maintained as is. When a voltage detected by the decreased driving current If has a value smaller than the second reference signal VR2 (at the timing t6, the second comparator U2 may output the lower limit control signal LL to the switch controller 32).

At this time, in order to drive a smaller number of LEDs according to the lower limit control signal LL inputted from the second comparator U2, the switch controller 32 may be controlled to turn off the third switch SW3 in an ON state and turn on the second switch SW2 in an OFF state so as to only drive the first and second LED groups G1 and G2.

As for an operation during an interval from the timing t6 to the timing t7 (t6˜t7), as the third switch SW3 is turned off and the second switch SW2 is turned on, the driving voltage Vf of the LED is reduced and the driving current If is instantly increased. Specifically, the driving current If at the timing t6 may be changed from

$$If = \frac{V 1 - 3 Vf 0}{R 1 + R 2} to If = \frac{V 1 - 2 Vf 0}{R 1 + R 2} .$$

Similar to the interval from the timing t5 to the timing t6 (i.e., t5˜t6), the increased driving current If is reduced according to the reduction in the DC power voltage V1. At the timing t7 when the second comparator U2 generates the lower limit control signal LL toward the switch controller 32, the second switch SW2 is turned off and the first switch SW1 is turned on, and at this time, the second LED group G2 does not operate. At this time, the driving current If at the timing t7 may be changed from

$$If = \frac{V 1 - 2 Vf 0}{R 1 + R 2} to If = \frac{V 1 - Vf 0}{R 1 + R 2} .$$

As for an operation during an interval from the timing t7 to the timing t8 (i.e., t7˜t8), only the first LED group G1 is driven according to the operations of the first and second switches SW1 and SW2 at the timing t7, and when the DC power voltage V1 is further reduced to a level at which even the first LED group G1 cannot be driven, the first LED group G1 is turned off.

After the timing t8, the rectified DC power voltage V1, passing the lowermost point, is increased again, so the operations during the interval from the timing t1 to the timing t8 (t1˜t8) are repeatedly performed.

In the embodiment of the present disclosure, any one of the first to third switches SW1, SW2, and SW3 constituting the switch 33 is turned on or all the switches are turned off, but two or more switches are not simultaneously turned on. Here, when the nth switch is turned on, whether or not the (n+1)th switch and the subsequent switches are turned on or off does not affect the operation of the driving circuit.

As illustrated in FIG. 3B, as the rectified DC power voltage V1 is increased, the first to third switches SW1, SW2, and SW3 are sequentially turned on and subsequently turned off, and when the rectified DC power voltage V1 starts to be reduced from a peak, the third switch, the second switch, and the first switch are sequentially turned on.

Accordingly, the first to fourth LED groups G1, G2, G3, and G4 are sequentially turned on during an interval in which the rectified DC power voltage V1 is increased (here, the first to fourth LED groups G1, G2, G3, and G4 being sequentially turned on means that the second to fourth LED groups G2, G3, and G4 are turned on in addition to the first LED group G1, rather than that the first LED group G1 is turned off and the second LED group G2 is subsequently turned on). The fourth to firth LED groups G4, G3, G2, and G1 are sequentially turned off during an interval in which the rectified DC power voltage V1 is reduced.

According to the embodiment of the present disclosure, the driving current flowing in the rectifying unit 10 based on a change in the rectified DC voltage V1 is detected and compared with the pre-set upper limit current value If(UL) and the lower limit current value If(LL) to control switches, thereby adjusting the number of driven LEDs. That is, since a different number of LEDs can be controlled to be driven according to intervals by using only the switches and resistor even without a current driving circuit for driving currents having different magnitudes according to respective intervals, the configuration is simplified and power consumption is reduced, thereby providing an LED driving circuit having an enhanced power efficiency.

In another embodiment of the present disclosure, unlike the embodiment illustrated in FIG. 2, in order to drive different numbers of the first to fourth LED groups G1, G2, G3, and G4 according to the magnitude of the rectified DC power voltage V1, a method of controlling switches according to the magnitude of driving voltages of the respective first to fourth LED groups G1, G2, G3, and G4 may be employed.

In detail, when the rectified DC power voltage V1 is between the driving voltage of the first LED group G1 and the driving voltages of the first and second LED groups G1 and G2, the first switch SW1 may be controlled to be turned on to allow a current to pass through only the first LED group G1 to flow to the ground GND, and at the timing t2 at which the rectified DC power voltage V1 becomes greater than the driving voltages of the first and second LED groups G1 and G2, the first switch SW1 may be controlled to be turned off and the second switch SW2 may be controlled to be turned on to allow the driving current If to flow to the ground GND through the first and second LED groups G1 and G2.

In this case, however, since the respective LEDs have tolerance with respect to driving voltages thereof, the control intervals of the switches should be designed in consideration of the tolerance. That is, when an average driving voltage of the LED groups is Vf(typical) and a maximum driving voltage within tolerance is Vf(max), if a threshold voltage of the switches is set based on the average driving voltage Vf(typical), the LED groups may not be turned on according to an operation of the switches.

For example, referring to FIG. 2, it is assumed that when the rectified power voltage V1 reaches the average driving voltage value Vf(typical) of the first to third LED groups G1, G2, and G3 while the second switch SW2 is turned on and the first and second LED groups G1 and G2 are driven, the third switch SW3 is controlled to be turned on. Here, if the driving voltage of the third LED group G3 has a maximum value Vf(max), the rectified DC power voltage V1 has a value smaller than the driving voltage Vf(max) of the third LED group G1 although the third switch SW3 is turned on, and as a result, the first to third LED groups G1, G2, and G3 cannot be driven.

Thus, in order to prevent an occurrence of such a phenomenon, a threshold voltage value of the switches should be designed based on the maximum driving voltage value Vf(max) within tolerance with respect to the entirety of the first to fourth LED groups G1, G2, G3, and G4. That is, in case of n number of switches, a threshold voltage for driving the nth LED group should be set to n×Vf(max) (in case in which the first to nth LED groups include a single LED having the same driving voltage Vf, respectively), and since a power loss (Vf(max)−Vf(min)) due to tolerance of the driving voltage is increased in proportion to the number (n) of switches, power efficiency is reduced as the number of switches is increased.

Also, since respective switches should be controlled according to the driving voltage, comparators corresponding to the number of switches, a circuit for detecting an ON/OFF state of each switch, and a current driving circuit for driving different currents according to a state of each switch are required, resulting in a complicated circuit configuration and additional power requirement.

Meanwhile, in order to reduce the size of the driving circuit, a circuit part for driving a current is required to be installed within an integrated circuit (IC). In this case, however, since a driving current flows within the IC, generating high power consumption within the IC, the solution is thermally disadvantageous and has a limitation in power consumption of the IC, and thus, there is a difficulty in an operation in an environment in which an ambient temperature is high and it is difficult to cope with high power by one unit.

In comparison with the aforementioned embodiment of controlling switches according to the magnitude of driving voltages of the respective first to fourth LED groups G1, G2, G3, and G4, in the light emitting device according to the embodiment of the present disclosure illustrated in FIG. 2, each switch can be automatically controlled by detecting a magnitude of the driving current If flowing in the light source unit 20, rather than detecting a state of each switch according to a magnitude of a driving voltage of each LED group and directly controlling each switch.

That is, it is not a method of controlling a switch in consideration of a magnitude of a driving voltage of each LED group, a power loss according to an increase in the number of switches is not made, thereby providing a highly efficient light emitting device.

Also, a comparator or an operational amplifier are not required for the respective first to nth LED groups. Rather, only the two comparators U1 and U2 for comparing whether or not a driving current is between the upper limit current value If(UL) and the lower current value If(LL) or the operational amplifier are required. Meanwhile, without the necessity of an additional current driving circuit for driving a pre-set current with respect to each of the first to nth LED groups, the plurality of LED groups can be individually driven and controlled by a simple circuit including the switches and resistor.

Also, in the embodiment of the present disclosure, since the driving current If does not flow within the IC, low power consumption and heat generation occur, thus being advantageous for an operation in an environment in which a temperature is high. Also, since the resistor and the switches (e.g., FETs) are positioned outside of the IC, the degree of freedom of designing is high and it is possible to cope with power having a relatively large range by one unit.

Also, when the same power is required for external commercial power of 200V system and 100V system, the driving current If of the 100V system is about double that of the 200V system. Thus, in order to apply the same IC to the 200V system and 100V system, the costs and the circuit size are increased.

In comparison, however, in the present embedment, since the driving current If does not flow within the IC, an IC applicable to both 200V system-based power source and 100V system-based power source can be easily designed.

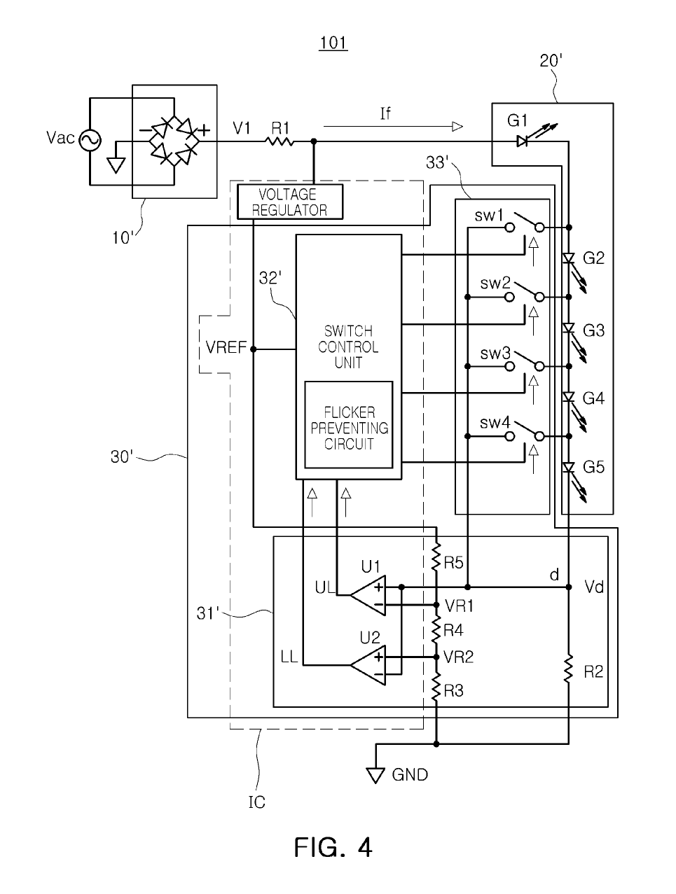

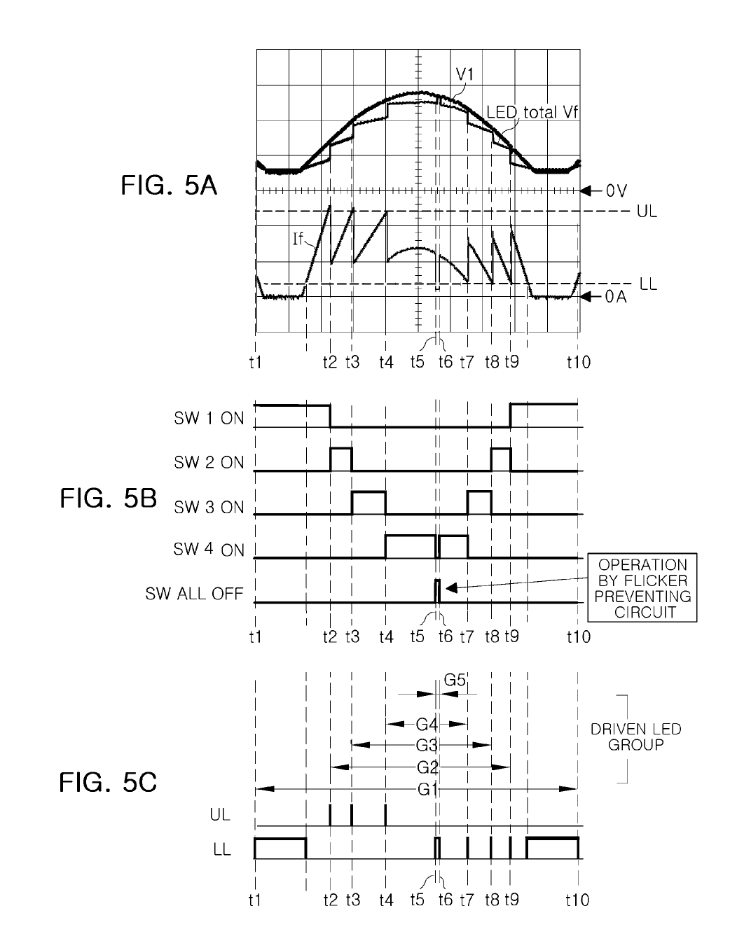

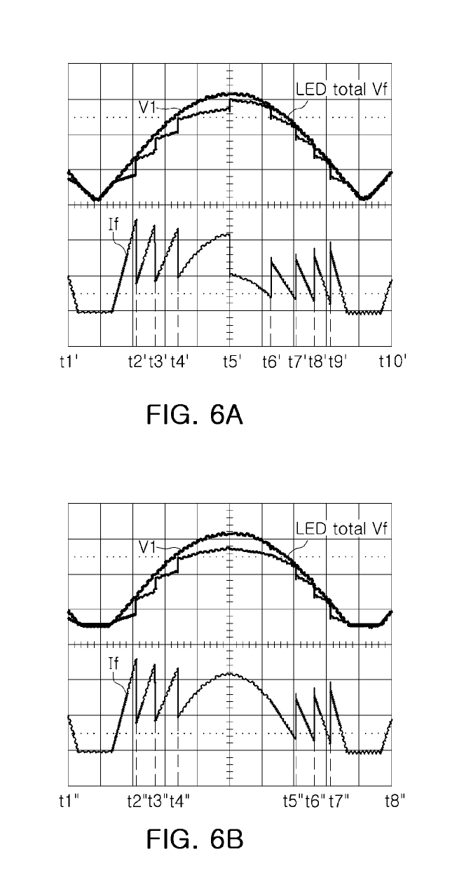

FIG. 4 is a view schematically illustrating a light emitting device 101 including a power supply device 30′ and a driving device (IC) according to another embodiment of the present disclosure. FIG. 5 is a view illustrating waveforms of voltages and currents that may be driven by the power supply device 30′ and the driving device (IC) illustrated in FIG. 4. FIG. 6 is a view illustrating operations of the power supply device 30′ and the driving device (IC) illustrated in FIGS. 4 and 5.

First, referring to FIG. 4, the power supply device 30′ according to the embodiment of the present disclosure supplies DC power to a light source unit 20′, and detects a current flowing in the light source unit 20′. When the detected current is outside a pre-set current range, the power supply device 30′ may control to change the number of light sources driven in the light source unit 20′.

Also, the power supply device 30′ may further include a rectifying unit 10′ converting AC power inputted from the outside into DC power. The power supply device 30′ may control the current flowing in the light source unit 20′ including first to fifth LED groups G1, G2, G3, G4, and G5 sequentially connected in series and driven by the DC power converted by the rectifying unit 10′.

The power supply device 30′ according to the embodiment of the present disclosure may include a comparator 31′ comparing an input signal generated by detecting a current flowing in the light source unit 20′ with a reference signal, and outputting a switch control signal, a switch controller 32′ controlling an ON/OFF operation of the switch upon receiving the switch control signal outputted from the comparator 31′, and a switch 33′ connected to the output terminals of the first to fifth LED groups G1, G2, G3, G4, and G5 to change a path of a driving current according to a signal inputted from the switch controller 32′.

In the embodiment of the present disclosure, a flicker preventing circuit may be further included in the power supply device 30 and the driving circuit IC according to the embodiment illustrated in FIG. 2.

Referring to FIGS. 4 and 5, the power supply device 30′ according to the embodiment of the present disclosure may be driven in a similar manner to that of the power supply device 30 illustrated in FIGS. 2 and 3.

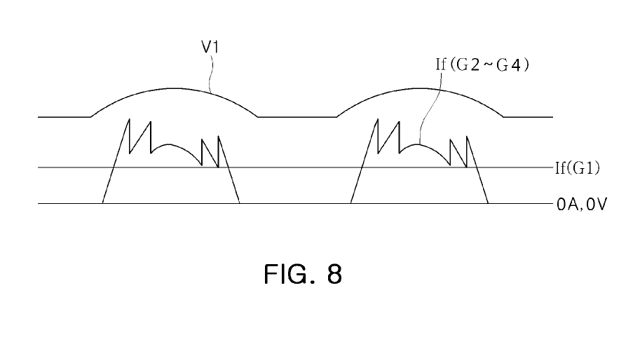

In detail, in the voltage and current waveforms illustrated in FIG. 5, an interval t1˜t4 is similar to the interval t1˜t4 illustrated in FIG. 3, an interval t7˜t10 is similar to the interval t5˜t8 illustrated in FIG. 8. There is a difference in operation only during the interval t4˜t7 including a peak of the rectified DC power voltage V1, so the operation during the interval t3˜t7 will be described briefly.

First, when the voltage Vd detected by the reduced driving current If is between the first reference signal VR1 and the second reference signal VR2 during the interval t3˜t4, i.e., in case of VR2<Vd<VR1, the driving current If flows through the first to third LED groups G1, G2, and G3.

As the rectified DC power voltage V1 is increased, the driving current If is gradually increased, and when the voltage Vd detected by the driving current If is greater than the first reference voltage VR1 (at the timing t4), the switch controller 32′ may be controlled to turned off the third switch SW3 and turn on a fourth switch SW4 to allow the driving current If to flow through the first to fourth LED groups G1, G2, G3, and G4.

Next, as for an operation during an interval t4˜t7 excluding interval t4˜t6, when the fourth switch SW4 is turned on at the timing t4 and the voltage Vd detected by the driving current If in the comparator 31′ is between the first reference voltage VR1 and the second reference voltage VR2, the fourth switch SW4 is maintained in the ON state.

In comparison to the waveforms illustrated in FIG. 3, where all the switches are in an OFF state as the third switch SW3 is turned off in FIG. 3C, in FIG. 5C, the third switch SW3 is turned off and the fourth switch SW4 is turned on, but both operations are similar in performing to drive the fourth LED group G4.

When the rectified DC power voltage V1 starts to be reduced from the peak during an interval t4˜t7, the driving current If is also reduced according to the reduction in the DC power voltage V1. When the voltage Vd detected by the reduced driving current If is smaller than the second reference signal VR2 of the second comparator U2, i.e., when the timing t7 arrives, the second comparator U2 outputs the lower limit control signal LL to the switch controller 32′ to control the switch controller 32′ to turn off the fourth switch SW4 and turn on the third switch SW3 to reduce the number of driven LEDs. In this case, the fourth LED group G4 is turned off, and only the first to third LED groups G1, G2, and G3 are driven.

FIG. 5B shows an ON/OFF operation of the first to fourth switches SW1, SW2, SW3, and SW4. FIG. 5C illustrates signals detected from the first and second comparators U1 and U2 of the comparator 31′ and LED groups driven according to the signals.

A subsequent operation is the same as described above with reference to FIGS. 2 and 3, so a description thereof will be omitted.

As for waveforms of the driving current If illustrated in a lower portion of FIG. 5A, the driving current If during the interval t4˜t7 in which the rectified DC power voltage V1 has a peak is maintained below the upper limit control value UL.

However, it may happen that the driving current If is equal to the upper limit of the first comparator U1 (If=If(UL)) by chance in the peak of the DC power voltage V1 due to a change in the rectified DC power voltage V1 or tolerance of the driving voltages Vf of the respective LED groups.

In particular, in case of approximating the waveform of the driving voltage (LED total Vf) of the LED groups and the waveform of the rectified DC power voltage V1 to the maximum level to enhance driving efficiency, driving efficiency may be enhanced but there is a high possibility that the driving current If is equal to the upper limit current value (If(UL)) during an interval including the peaks of the voltages.

In this case, the first comparator U1 generates the upper limit control signal UL toward the switch controller 32′ to change an operation of a switch and perform a subsequent stage as illustrated in FIG. 6A, or the previous stage may be maintained as is without generating the upper limit control signal UL as illustrated in FIG. 6B.

Here, there is no problem with fixation to proceeding to the subsequent stage (FIG. 6A) or to maintaining the previous stage as is (FIG. 6B). However, when different waveforms illustrated in FIGS. 6A and 6B appear alternately such that a subsequent stage is performed in one period and a previous stage is maintained as is in a next period, or the like, a change in brightness has a frequency lower than 120 Hz or 100 Hz, which may be recognized as a flicker by the human eyes.

Hereinafter, an operation of the circuit illustrated in FIG. 6A and FIG. 6B will be described in detail.

First, referring to FIG. 6A, an operation during an interval t1′˜t4′ is similar to that of the interval t1˜t4 illustrated in FIGS. 3A and 5A. Meanwhile, when the driving current If is equal to an upper limit of the first comparator U1 when the first to fourth LED groups G1, G2, G3, and G4 are driven during an interval t4′˜t5′, the first to fourth switches SW1, SW2, SW3, and SW4 are turned off to drive a larger number of LEDs, and thus, the first to fifth LED groups G1, G2, G3, G4, and G5 are driven.

When the number of driven LEDs is increased, the driving current If is instantly reduced (at the timing t5′). During an interval t5′˜t6′, as the rectified power voltage V1 is reduced from the peak, the driving current If is also reduced together, and when the driving current If is reduced to be lower than the lower limit of the second comparator U2, the switch controller 32′ is controlled by the lower limit control signal LL outputted from the second comparator U2 to turn on the fourth switch SW4 to drive a smaller number of LEDs. An operation after the timing t6′ is similar to the operation after the timing t7 in FIGS. 5A-5C.

Meanwhile, in the case of FIG. 6B, an operation similar to that of FIG. 5B, except for the interval t5˜t6 in FIG. 5, is performed, so the fifth LED group G5 is not turned on.

Thus, when the upper limit control signal UL is not generated by the first comparator U1 during a certain period (t4˜t5 in FIG. 5A) during an interval from a timing (t2) at which the first upper limit control signal UL was generated by the first comparator U1 to a timing at which the first lower limit control signal LL was generated by the second comparator U2, in order to prevent an occurrence of a flickering phenomenon due to an irregular appearance of waveforms illustrated in FIGS. 6A and 6B, a dummy pulse is forcibly generated to surely perform a subsequent stage, thus restraining a flickering phenomenon.

That is, when the driving current If is equal to the upper limit current value If(UL) detected by the first comparator U1, a subsequent stage is performed to have the waveforms illustrated in FIG. 6A, thus preventing a flickering phenomenon from occurring as different waveforms appear according to periods

In the power supply device 30′ according to the embodiment of the present disclosure, when the upper limit control signal UL is not generated by the first comparator U1 during a certain period during an interval from a timing t2 at which the first upper limit control signal UL was generated by the first comparator U1 to a timing at which the first lower limit control signal LL was generated by the second comparator U2, a dummy pulse is generated by the first comparator U1 (t5˜t6), whereby an operation for preventing flickering can be performed during the interval t4˜t7 in which the rectified DC power voltage V1 is the highest.

As illustrated in FIGS. 5A-5C, when there is no change in the stage during a certain period of time (t4˜t5) regardless of whether the driving current If is equal to the upper limit UL of the first comparator U1 during an interval including the peak of the rectified DC power voltage V1 (i.e., an interval during which the largest number of LED groups can be driven), when the subsequent stage is forcibly performed, the fifth LED group G5 can be constantly turned on within one period, thus reducing a flickering phenomenon.

In this case, as illustrated in FIGS. 5A-5C, even when the driving current is operated within a current range prescribed with the upper limit UL and the lower limit, all the switches are forcibly turned off to allow the fifth LED group G5 to be driven at the predetermined timing t5, whereby the driving current flows through the first to fifth LED groups G1, G2, G3, G4, and G5. At this time, as the driving voltage Vf is increased by the fifth LED group G5, the driving current If is reduced. When the reduced driving current If becomes smaller than the lower limit If(LL) of the second comparator, the switch controller 32′ controls the switch to reduce the number of driven LEDs to proceed to a subsequent stage (t6˜t7) in which the fourth switch SW4 is turned on and the first to fourth LED groups G1, G2, G3, and G4 are driven.

In another embodiment of the present disclosure, a driving device (IC) may be included to drive the light source units 20 and 20′, and the driving device (IC) may include a comparator comparing an input signal with a reference signal and outputting a control signal when the input signal is outside a pre-set current range and a switch controller receiving the control signal outputted from the comparator and outputting a signal for changing the number of driven light sources when the control signal is inputted to the switch controller.

The driving device (IC) may be understood to denote the IC regions (including the voltage regulator, the switch controller 32, and the comparator 31) indicated by the dotted lines in the light emitting devices 100 and 101 according to the embodiments illustrated in FIGS. 2 and 4, and here, the voltage regulator may be omitted as necessary.

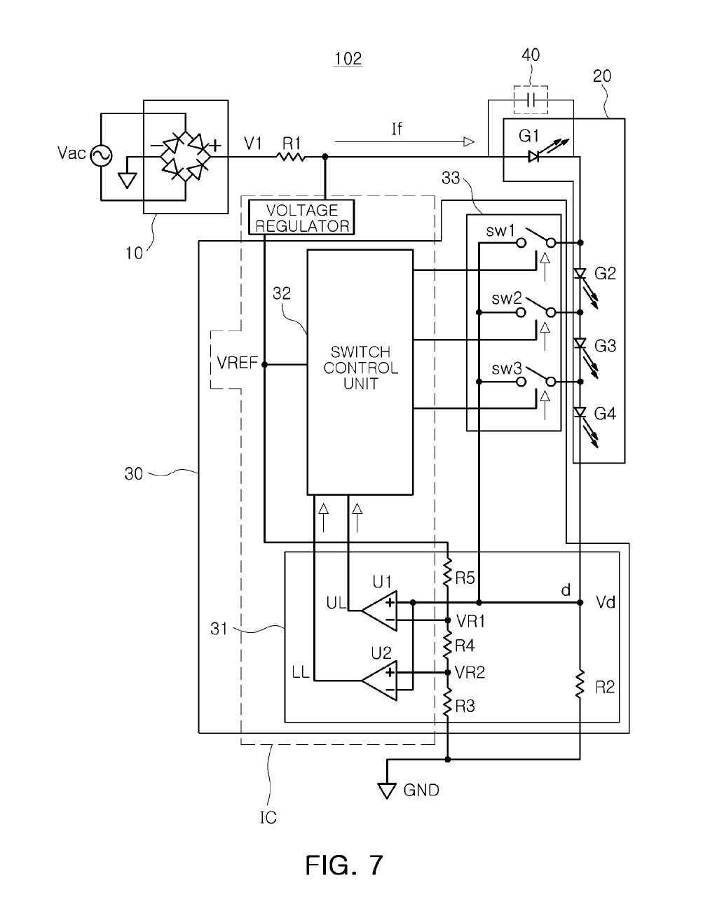

FIG. 7 is a view illustrating a light emitting device 102 including a power supply device 30 and a driving device (IC) according to another embodiment of the present disclosure. FIG. 8 is a view schematically illustrating waveforms of voltages and currents applicable to the power supply device and the driving device according to another embodiment of the present disclosure.

First, referring to FIG. 7, the power supply device 30, the driving device (IC) and the light emitting device 102 including the power supply device 30 and the driving device (IC) have a configuration in which a condenser 40 is added to the light source unit 20 in the embodiment illustrated in FIG. 2. The other components than the condenser 40 may be understood to be similar to those illustrated in FIG. 2. Thus, only the different component will be described hereinafter.

Referring to FIG. 7, the power supply device 30, the driving device (IC), and the light emitting device 102 may include the condenser 40 connected to at least a portion of light sources driven in the light source unit 20 connected to an output terminal of the rectifier 10. The light source unit 20 may include first to nth LED groups sequentially connected in series to the output terminal of the rectifying unit 10. The condenser 40 may be connected to both ends of the first LED group G1 positioned nearest to the output terminal of the rectifying unit 10.

Hereinafter, the first to nth LED groups G1, G2, . . . , Gn will be described as the first to fourth LED groups G1, G2, G3, and G4 as illustrated in FIG. 7 for the purposes of description, but the number and connection configuration of the LED groups constituting the light source unit 20 may be variably modified as necessary.

The condenser 40 may be connected to be parallel to at least a portion of light sources driven in the light source unit 20 to prevent all the LED groups from being turned off in the light source unit 20 through a current charged when power is supplied from the rectifying unit 10.

In detail, when power is applied in an early stage and the voltage V1 outputted from the rectifying unit 10 rises from 0V, the first LED group G1, among the first to nth LED groups G1, G2, . . . , Gn in a turned-off state, is first turned on. When the rectified DC power voltage V1 rises and the first comparator U1 outputs the upper limit control signal UL, the second and third switches Q2 and Q3 are sequentially turned on, and thus, the first to third LED groups G1, G2, and G3 are sequentially turned on. Meanwhile, after the first to third LED groups G1, G2, and G3 are turned on, when all the switches Q1, Q2, Q3, and Q4 are turned off, the first to fourth LED groups G1, G2, G3, and G4 are turned on. When the magnitude of the rectified DC power voltage V1 starts to be reduced, the lower limit control signal LL is outputted from the second comparator U2 and the third to first switches Q3, Q2, and Q1 are sequentially turned on, thereby reducing the number of turned-on LED groups.

In case of a general AC driving circuit, when the rectified DC power voltage V1 is lowered to below a certain voltage, i.e., a voltage at which the first LED group G1 can be driven, the entirety of the light source unit 20 is turned off. However, according to the embodiment of the present disclosure, since the condenser 40 is connected to both ends of the first LED group G1 and a voltage charged in the condenser 40 is supplied at below a certain level to the light source unit 20, the first LED group G1 is prevented from being turned off during every interval.

Thus, since at least one LED group is turned on during every interval, thereby eliminating an interval during which the entirety of the light source 20 is turned off, a flickering phenomenon can be improved. In detail, a flicker reference standard that an interval having a value equal to or lower than 5% of an optical power peak value should not be present, or the like, can be satisfied which cannot be satisfied by a general AC LED circuit.

FIG. 8 is a view schematically illustrating waveforms of voltages and currents applicable to the power supply device and the driving device illustrated in FIG. 7.

Referring to FIG. 8, the rectified DC voltage V1 input to the light source unit 20 after being outputted from the rectifying unit 10 is constantly maintained as a uniform voltage value by the condenser 40. Accordingly, the first LED group G1 is maintained by the condenser 40 connected to both ends thereof such that a uniform current I(G1) flows therethrough.

Meanwhile, currents I(G2˜G4) flowing in the second to fourth LED groups G2, G3, and G4 have saw tooth waveforms similar to those of the first to fourth LED groups G1 to G4 illustrated in FIGS. 3A-3B.

In the embodiment of the present disclosure, the number of LED groups to which the condenser 40 is connected may be one or more groups selected as necessary, and in case of connecting the condenser 40 to one LED group, a small low-pressure condenser can be applicable, so flickering can be improved by a small, simple circuit. Also, capacity components are not connected in parallel in the majority of LEDs, so in the embodiment of the present disclosure, a flickering phenomenon can be improved without degrading a power factor.

When the rectified DC power voltage V1 is lower than a driving voltage of the least LED group (e.g., the first LED group), all the LEDs are turned off. In order to address this problem, the condenser may be connected to the output terminal of the rectifying unit 10. In this case, however, the power factor (PF) is degraded by the input condenser and a high withstand voltage condenser is required, and thus, the driving device is increased in size.

However, in the embodiment of the present disclosure, since the condenser 40 is connected to both ends of a portion of the LED groups of the light source unit 20, flickering can be improved by a simple configuration without degrading the power factor. Also, since the employed condenser has a low withstand voltage, the device can become compact, economical, and effectively cope with a triac dimmer.

In FIG. 7, the driving device, the power supply device, and the light emitting device according to the embodiment illustrated in FIG. 2 have been described, but the present disclosure is not limited thereto and it will be appreciated by a person skilled in the art that the present disclosure can be applicable in a similar manner to the embodiment including the flicker preventing circuit illustrated in FIG. 8.

As set forth above, according to embodiments of the disclosure, the light emitting device configured to have a simple circuit and driven at low costs and with a high level of efficiency and an LED driving method can be provided.

Although embodiments of the present disclosure have been shown and described, it will be appreciated by those skilled in the art that changes may be made without departing from the principles and spirit of the present disclosure, the scope of which is defined in the appended claims.

What is claimed is:

1. A power supply device, which supplies DC power to a light source unit having a plurality of light sources, comprising a driving device configured to:
determine whether a current flowing in the light source unit is outside a pre-set current range; and
change the number of light sources driven in the light source unit when the current flowing in the light source unit is outside the pre-set current range.

2. The power supply device of claim 1, wherein:
the driving device detects the current flowing in the light source unit at an output terminal of the light source unit to generate an input signal, and
the driving device compares the input signal with a reference signal to determine whether or not the input signal is outside the pre-set current range.

3. The power supply device of claim 2, wherein the driving device comprises:
a comparator configured to compare the input signal generated upon detecting the current flowing in the light source unit with the reference signal, and output a control signal when the input signal is outside the pre-set current range;
a switch controller configured to receive the control signal outputted from the comparator, and output a signal for changing the number of light sources driven in the light source unit when the control signal is inputted to the switch controller; and
a switch connected to the light source unit and configured to be turned on or off according to a signal outputted from the switch controller.

4. The power supply device of claim 3, wherein:
when the detected current from the output terminal of the light source unit is outside the pre-set current range, the comparator outputs one of an upper limit control signal and a lower limit control signal.

5. The power supply device of claim 4, wherein:
when the upper limit control signal is inputted, the switch controller outputs a first control signal to increase the number of driven light sources, and
when the lower limit control signal is inputted, the switch controller outputs a second control signal to decrease the number of driven light sources.

6. The power supply device of claim 1, wherein:
the driving device further comprises a condenser connected in parallel with at least a portion of the light sources driven in the light source unit,
the light source unit includes first to nth LED groups sequentially connected in series, and
the condenser is connected to two ends of the first LED group.

7. The power supply device of claim 1, wherein the driving device further comprises:
a condenser connected in parallel with at least a portion of the light sources driven in the light source unit;
a comparator configured to detect the current flowing in the light source unit at an output terminal of the light source unit to generate an input signal, compare the input signal with a reference signal, and output one of an upper limit control signal and a lower limit control signal when the input signal is outside the pre-set current range;
a switch controller configured to receive the one of the upper limit control signal and the lower limit control signal outputted from the comparator, and output a signal for changing the number of light sources driven in the light source unit when the one of the upper limit control signal and the lower limit control signal is inputted to the switch controller;
a switch connected to the light source unit and configured to be turned on or off according to a signal outputted from the switch controller; and
a flicker preventing circuit configured to forcibly turn the switch off, when the upper limit control signal is not outputted during a certain period within an interval from a point time when the upper limit control signal is first outputted to a point time when the lower limit control signal is first output, in one cycle of driving of the DC power.

8. The power supply device of claim 1, wherein the driving device further comprise:
a condenser connected in parallel with at least a portion of the light sources driven in the light source unit;
a comparator configured to detect the current flowing in the light source unit at an output terminal of the light source unit to generate an input signal, compare the input signal with a reference signal, and output a control signal when the input signal is outside the pre-set current range;
a switch controller configured to receive the control signal outputted from the comparator, and output a signal for changing the number of light sources driven in the light source unit when the control signal is inputted to the switch controller; and
a switch connected to the light source unit and configured to be turned on or off according to a signal outputted from the switch controller, wherein:
the comparator includes a first comparator and a second comparator,
the first comparator is configured to compare the input signal with a first reference signal, and output an upper limit control signal when the input signal is greater than the first reference signal, and
the second comparator is configured to compare the input signal with a second reference signal, and output a lower limit control signal when the input signal is smaller than the second reference signal.

9. The power supply device of claim 8, wherein:
the first and second comparators are operational amplifiers,
the first reference signal is inputted to an inverting input terminal of the first comparator and the input signal is inputted to a non-inverting input terminal of the first comparator, and
the input signal is inputted to an inverting input terminal of the second comparator, and the second reference signal is inputted to a non-inverting input terminal of the second comparator.

10. The power supply device of claim 8, further comprising:
a voltage regulator configured to output a certain voltage upon receiving a portion of the DC power; and
a plurality of resistors connected in series between an output terminal of the voltage regulator and a ground,
wherein each of the first reference signal and the second reference signal is set to have a voltage distributed by the plurality of resistors.

11. The power supply device of claim 3, wherein:
the comparator further comprises a current detection resistor connected between the output terminal of the light source unit and a ground, and
the input signal is generated in the form of a voltage over the current detection resistor.

12. The power supply device of claim 11, wherein:
the light source unit includes first to nth LED groups sequentially connected in series, and
the switch includes first to (n−1)th switches connected between output terminals of the first to (n−1)th LED groups and the current detection resistor, respectively.

13. A driving device, comprising:
a comparator configured to compare an input signal with a reference signal, and output a control signal when the input signal is outside a current range previously set based on the reference signal; and
a switch controller configured to receive the control signal outputted from the comparator, and output a signal for changing the number of light sources driven in a light source unit when the control signal is inputted to the switch controller.

14. The driving device of claim 13, wherein:
when the input signal is outside the current range previously set based on the reference signal, the comparator outputs one of an upper limit control signal and a lower limit control signal.

15. The driving device of claim 14, wherein:
when the upper limit control signal is inputted, the switch controller outputs a first control signal to increase the number of driven light sources, and
when the lower limit control signal is inputted, the switch controller outputs a second control signal to decrease the number of driven light sources.

16. The driving device of claim 13, wherein:
the driving device further comprises a condenser connected in parallel with at least a portion of light sources driven in the light source unit,
the light source unit includes first to nth LED groups, and
the condenser is connected to two ends of the first LED group.

17. The driving device of claim 13, wherein:
the driving device further comprises a condenser connected in parallel with at least a portion of light sources driven in the light source unit,
the comparator outputs one of an upper limit control signal and a lower limit control signal when the input signal is outside the current range previously set based on the reference signal,
the driving device further comprises a flicker preventing circuit configured to forcibly turn off the switch controlled by the switch controller, when the upper limit control signal is not outputted during a certain period within an interval from a point time when the upper limit control signal is first outputted to a point time when the lower limit control signal is first output, in one cycle of driving of the DC power.

18. The driving device of claim 20, wherein:
the driving device further comprises a condenser connected in parallel with at least a portion of light sources driven in the light source unit,
the comparator comprises:
a first comparator configured to compare the input signal with a first reference signal, and output an upper limit control signal when the input signal is greater than the first reference signal; and
a second comparator configured to compare the input signal with a second reference signal, and output a lower limit control signal when the input signal is smaller than a second reference signal.

19. The driving device of claim 18, wherein:
the first and second comparators are operational amplifiers,
the first reference signal is inputted to an inverting input terminal of the first comparator and the input signal is inputted to a non-inverting input terminal of the first comparator, and
the input signal is inputted to an inverting input terminal of the second comparator and the second reference signal is inputted to a non-inverting input terminal of the second comparator.

20. The driving device of claim 18, further comprising:
a voltage regulator configured to output a certain voltage upon receiving a portion of the DC power; and
a plurality of resistors connected in series to an output terminal of the voltage regulator,
wherein each of the first reference signal and the second reference signal is set to have a voltage distributed by the plurality of resistors.
